(19) United States
(12) Patent Application Publication
(10) Pub. No.: US 2022/0203309 A1
(43) Pub. Date: Jun. 30, 2022

(54) DEVICE AND METHOD FOR MAKING A CARBONATED BEVERAGE

(71) Applicant: Shlomo Uri Haimi, Or Akiva (IL)

(72) Inventor: Shlomo Uri Haimi, Or Akiva (IL)

(21) Appl. No.: 17/134,414

(22) Filed: Dec. 27, 2020

(51) Int. Cl. B01F 3/04

(52) U.S. Cl. CPC B01F 3/04794; B01F 3/04815; B01F 2215/0022; B01F 2003/049; B01F 2003/04822

(57) ABSTRACT

A system for introducing pressurized gas into a liquid, including: (a) a housing adapted to receive a canister of pressurized gas, the housing including a threaded internal surface to receive a threaded neck of the canister; (b) an applicator in fluid communication with the canister and operationally coupled to the housing; (c) a liquid container adapted to hold therein a carbonated beverage; (d) a receiving port adapted to be reversibly mated with the applicator in an airtight coupling so as to facilitate fluid communication of the pressurized gas into the liquid container.

### FIELD OF THE INVENTION

The present invention relates to beverage carbonation and, more particularly, to an apparatus and method for carbonating a beverage.

### BACKGROUND OF THE INVENTION

In the field of do-it-yourself beverage carbonation, there are a small number of companies that have cornered the market on home carbonation. There are two main methods of carbonation: infusion of pressurized gas (e.g. carbon dioxide) and chemical reaction.

In the sub-category of gas infusion, all the systems suffer from at least the drawback of loss of carbonation due to the beverage being open to the ambient air for a collectively long period of time. Initially, pressurization is lost during the carbonation process itself, as the bottle is open, and the gas infused through the mouth of the bottle. Thereafter, every time the bottle is opened to pour out the beverage, more pressurized gas is released.

### SUMMARY OF THE INVENTION

The instant process and system is a gas infusion carbonation process that provides a solution for retaining a high percentage of infused gas both during the carbonation process as well as whenever the carbonated beverage is dispensed. After the liquid (water and flavoring or other liquid) is placed in the bottle, the bottle is closed with an airtight lid which remains closed during the carbonation process and thereafter, until the beverage has been completely consumed.

According to the present invention there is provided a system for introducing pressurized gas into a liquid, including: (a) a housing adapted to receive a canister of pressurized gas, the housing including a threaded internal surface to receive a threaded neck of the canister; (b) an applicator in fluid communication with the canister and operationally coupled to the housing; (c) a liquid container adapted to hold therein a carbonated beverage; (d) a receiving port adapted to be reversibly mated with the applicator in an airtight coupling so as to facilitate fluid communication of the pressurized gas into the liquid container.

According to further features in preferred embodiments of the invention described below the system further includes an actuation mechanism for causing the pressurized gas to be communicated into the liquid container, the actuation mechanism being wiredly or wirelessly controlled.

According to still further features in the described preferred embodiments the actuation mechanism includes an actuator selected from the group comprising: a mechanical actuator, and an electro-mechanical actuator.

According to still further features the receiving port is embedded in a bottom surface of the liquid container or in a side wall of the liquid container.

According to still further features the system further includes a bottle lid, the bottle lid adapted to be removably coupled to a mouth of the liquid container so as to form an airtight coupling when closed over the mouth. According to still further features the bottle lid includes a dispensing mechanism for dispensing pressurized liquid from the liquid container without removing the bottle lid from the mouth of the liquid container. According to still further features the dispensing mechanism includes an airtight valve to prevent the pressurized gas from escaping the liquid container via the dispensing mechanism.

According to still further features the bottle lid includes a pressure relief valve adapted to release the pressurized gas from the liquid container when a pressure level inside the container is above a predetermined threshold and to continue to release the pressurized gas until the pressure level drops below the threshold. According to still further features the receiving port is integrated in the bottle lid.

According to still further features the receiving port has an outer side adapted to be external to the liquid container and an inner side adapted to be internal to the liquid container and a unidirectional valve disposed between the outer side and the inner side adapted to unidirectionally admit the pressurized gas from the outer side to the inner side.

According to still further features the applicator has a gasket disposed thereon for facilitating an airtight coupling with the receiving port. According to still further features the system further includes a sensing mechanism configured to determine whether the applicator is mated in the airtight coupling with the receiving port.

According to still further features the sensing mechanism is selected from the group comprising: a mechanical mechanism, an electro-optical mechanism and an electronic mechanism.

According to still further features the system further includes a metering selector for selecting an amount of the pressured gas to be released upon actuation. According to still further features the system further includes a velocity selector for selecting a velocity at which the pressured gas to be released upon actuation. According to still further features the system further includes a pulse selector for selecting a number of pulses of a predefined amount of the pressured gas to be released upon actuation.

According to still further features the system further includes a timer for controlling a duration during which the pressured gas is to be released upon actuation. According to still further features the system further includes at least one LED display adapted to indicate at least one of: a ready state, an in-use state, a number of pulses to be released, an amount of the pressured gas to be released.

According to still further features the housing further contains a locking mechanism adapted to secure the canister of pressurized gas therein.

### BRIEF DESCRIPTION OF THE DRAWINGS

Various embodiments are herein described, by way of example only, with reference to the accompanying drawings, wherein:

FIG. 1 is an exemplary implementation of a system for introducing pressurized gas into a bottled liquid.

### DESCRIPTION OF THE PREFERRED EMBODIMENTS

The principles and operation of a system for carbonating liquid according to the present invention may be better understood with reference to the drawings and the accompanying description.

The term “carbonate” and variations thereof are used herein to indicate the process of introducing pressurized gas in liquid and/or the product thereof. It is made clear that while the technical meaning of the term refers to the infusion of carbon dioxide into a beverage (carbon dioxide dissolved into liquid and contained under pressure), the term is also colloquially used to refer to any fizzy drink, even when carbon dioxide or carbonic acid was not employed to produce the bubbles in the beverage. The term, as used herein, is intended to encompass both interpretations unless specified otherwise.

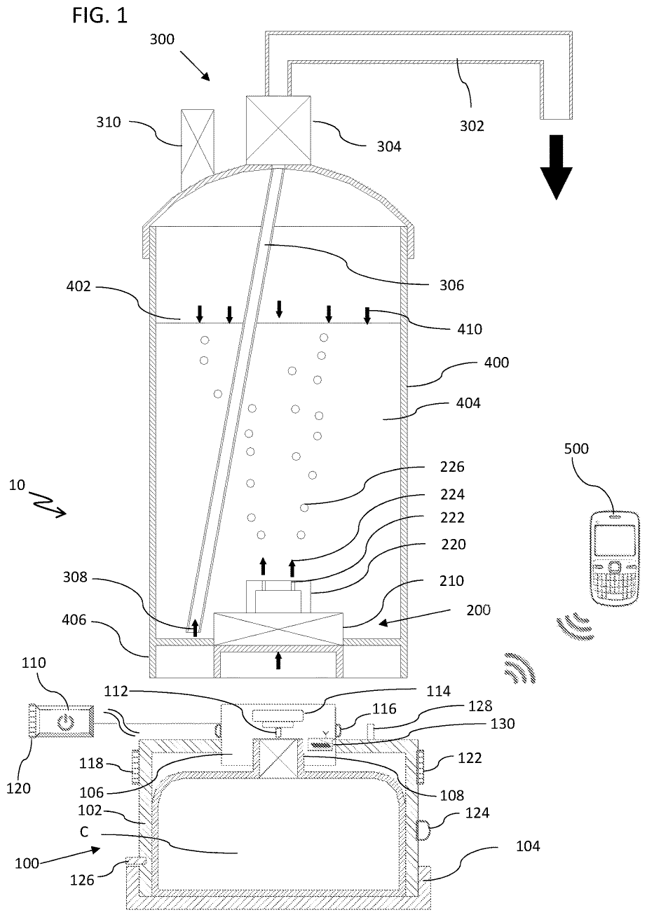

Referring now to the drawings, FIG. 1 illustrates an exemplary implementation of a system for introducing pressurized gas into a bottled liquid. The system 10 includes a canister housing 100 and a corresponding receiving port 200. The canister housing 100 houses a canister C of pressurized gas (e.g. carbon dioxide) which is to be introduced into the fluid airtightly held in a bottle 400. Preferably, a bottle cap/lid 300 is part of the system. The cap/lid is removed to introduce the fluid and/or flavoring and then airtightly closed over the mouth of the bottle prior to the carbonation process.

Housing—Base

The housing 100 includes various control features, optional sensors, locking mechanisms and more, all of which will be detailed hereafter. In the exemplary embodiment, the housing includes a top piece 102 and a bottom piece 104. The canister C is installed in an inside surface of the top piece. The bottom piece 104 interlocks with the top piece to securely lock the gas canister inside the housing. In some embodiments, the housing is formed from a single piece. Again, it is made clear that the structure of the housing is merely exemplary and is just one preferred manner of executing the invention.

In preferred embodiments, the housing further contains a locking mechanism adapted to secure the canister of pressurized gas inside the housing. For example, the bottom piece may be closed over the bottom of the gas canister and secured with a mechanical locking mechanism 126 that slides into a corresponding groove.

The gas canister is installed in the housing by screwing the threaded neck of the canister into a corresponding, [female] threaded socket defined by an internal surface 108 of an adaptor 106 that is part of the top piece 102 of the housing. Adaptor 106 further includes a gas release mechanism including an actuation pin 112 and a linear actuator 114 that moves the pin towards and away from the canister release valve. The actuation mechanism may be mechanical, such as a lever, or electro-mechanical such as a solenoid. The exemplary linear actuator 114 is a solenoid driven actuator. In general, gas canisters have a release mechanism that includes a pressurized valve in the mouth and neck of the canister with a spring-loaded release pin. The gas is released by depressing the release pin built into the gas canister. A button 110 controls the actuation mechanism. For an electro-mechanical mechanism, the button sends an electronic signal (e.g. an electric pulse) to the linear actuator. With a mechanical mechanism, the button 110 may be part of, or one end of, the mechanical lever or other mechanical actuator.

The housing with the canister installed therein, as depicted in the FIGURE, is intended to be a countertop appliance, also referred to herein as the base or base appliance 100. The carbonation process is initiated when a bottle 400 of liquid 404 that is airtightly closed with a lid 300 is mated with the base 100. The bottle 400 of liquid 404 with a receiving port 200 (either integrated in the bottom of the bottle or in the lid 300) is mounted on the base 100 by mating the adaptor 106 with the receiving port 200. Exemplarily, the mating arrangement is a screw-in arrangement, where the bottle screws into the base. Another exemplary mating arrangement is a twist-lock arrangement, well known in the art. Yet another arrangement includes an overhanging arm which is levered into a locking position over the bottle, locking the bottle to the base. Any other relevant locking and/or mating arrangement known in the art is considered to be within the scope of the innovation.

According to the exemplary embodiment, the base appliance includes the male component while the receiving port comprises the female component of the mating or docking arrangement. It is made clear that this configuration is merely exemplary and other configurations are envisioned. For example, according to another embodiment, the base includes a receptacle, female component and the receiving port includes a male-connector component docks with the receptacle. According to a same or different embodiment, the gas canister may be installed in a housing but coupled to the applicator 106 of the mating/docking arrangement via a pipe or tube. In such embodiments, the size, shape and location of the gas canister may vary from the depicted configuration in the FIGURE.

Whatever the configuration of the mating/docking arrangement is, it is preferable that a contact sensor 128 indicate when the base and bottle are correctly docked and, conversely. then they are not. The sensor must be positioned in a location where it can sense where a proper connection has been made or not. In the depicted, exemplary embodiment, the sensor may be a mechanical, electrical or electro-optical sensor disposed between the top surface of the base and the bottom surface of the bottle. For example, if the sensor is mechanical, it may be a spring-loaded mechanism that indicates a correct docking (or at least the presence of a bottle) when the rod of the spring-loaded mechanism is depressed to a predefined depth. As mentioned, the sensor may be an optical sensor, a pressure sensor or indeed any other type of sensor. Alternatively, a visual indicator may be mechanically revealed when the bottle is locked into place, as is known in the art, for example, from a door lock which indicates an occupied status when the lock is mechanically engages.

Release of the gas is a function of both depth and time, or velocity and duration. That is to say that the further in the pin is pushed, the greater the release velocity and the longer the pin is depressed, the longer the duration during which gas is released at the given velocity. (Some canisters have a security mechanism built into the canister whereby depressing the integrated pin a small amount releases the gas but depressing the pin too deeply closes the valve.)

The release of gas can therefore be defined according to the aforementioned parameters. For example, the depth can be preset and non-changing, with the amount of gas being release by controlling the amount of time the pin is depressed. Additionally, the amount of time can also be preset and non-changing, thereby controlling the amount of gas release by the number of times the mechanism is actuated.

Alternatively, the depth of depression can vary. For example, in an electro-mechanical mechanism, the depth can be set and changed by a depth/velocity selector 118. In the case of a mechanical actuator, the depth may also be preset and changeable with a similar selector 118 that mechanically restricts the depth to which the actuator pin can be depressed. Alternatively, there may be limitation from the actuator mechanism (the limitation being on the canister itself), but the user may exercise manual depth selection depending on how hard s/he depresses the lever or button. Actuator button 110 is depicted as separated from the housing, however, this is merely exemplary and not intended to be limiting in any way.

In combination with any of the aforementioned configurations, or independent therefrom, the duration of the gas releasing process may be controlled in one or more of the following ways. According to one configuration, there is no time limit imposed on the actuation process, for example, with a mechanical actuator, the amount of time the button, lever or other actuator is actuated is manually controlled by the user.

According to another configuration, there is a strict time limit on the actuation process. For example, with an electro-mechanical actuator, the actuation time is preset and non-changeable. Alternatively, a fixed mechanical timer can limit the duration of gas release per actuation. In such a configuration, a pulse selector 120 controls the number of times the mechanism is actuated and/or the number of pulses of a predefined amount of pressured gas to be released upon actuation.

According to another configuration, the amount of time (duration) the gas is released is selected and controlled by a timer 122 that controls the duration of the gas release. The timer may be a mechanical timer with a selectable timing mechanism (e.g. a spring-loaded timer that is manually preset), or electro-mechanical timer that is controlled with a digital timer.

According to embodiments, the housing further includes an activity light 124. The activity light may be one or more LEDs under one or more covers indicating activity or readiness for activity or both. The instant diagram depicts a single cover which may house one or more LEDs. Examples may include: a green light indicating that the housing is properly mated to receiving port and ready for use; a red light indicating that the device is active; an orange light or blinking red light indicating that the device is not properly mated and hence not in condition to be actuated.

Alternatively or additionally, the housing may include an LCD (or LED or other) display indicating a number of pulses to be released and/or indicating an amount of pressured gas to be released and/or a timer indicating when the beverage will be ready and/or any other displayable information that me be of use to the user.

An optional feature is a mechanical or electromechanical bubble size selector. The selector (not shown) controls the size of the aperture through which the gas flows into the bottle and accordingly the size of the bubbles in the liquid.

Receiving Port

The receiving port 200 may be integrated into a special purpose bottle as depicted in the FIGURE or it may be integrated into a bottle cap/lid. The user mates the housing 100 (with a canister C installed therein) with the receiving port 200. The bottle must include liquid, but must not be filled to the top. With a specialized bottle such as bottle 400 that is depicted in the FIGURE, the bottle has a marking 402 on the sidewall of the bottle that indicates the fluid limit.

With a specialized bottle 400, the receiving port protrudes from the bottom surface of the bottle. As such, is it necessary to have a bumper 406 at the bottom of the bottle so that the bottle can stand safely on a flat surface without tipping over. The bumper further hides the receiving port and protects it from damage. Furthermore, the specialized bottle is made from a material rated for containing a pressurized beverage. It is made clear that the location of the receiving port is merely exemplary and that the receiving port may be located in a sidewall of the bottle 400 or integrated into a lid 300 of the bottle 400 as described elsewhere herein.

The receiving port includes a one-way valve 210 that prevents liquid or gas from leaving the bottle but allows the applicator 106 to dispense pressurized gas via the valve into the bottle when the base and receiving port are mated. Accordingly, it can be generalized that receiving port 200 has an outer side adapted to be external to the liquid container and an inner side adapted to be internal to the liquid container and a unidirectional valve 210 disposed between the outer side and the inner side which is adapted to unidirectionally admit pressurized gas from the outer side to the inner side.

When docked, the applicator and receiving port form an airtight coupling, preventing gas (or liquid) from escaping. Exemplarily, applicator 106 is surrounded by a gasket 116 that ensures the airtight coupling. In some embodiments, the bottle may include a backup seal (not shown) that acts as a reinforcement for one-way valve 210 or as a watertight barrier should the one-way valve 210 fail.

Once the applicator and receiving port are mated, the button 110 is pressed and gas is released from the canister C. The gas is communicated through the applicator 106, through the one-way valve 210. The gas is propelled via piping 220 to exit openings 222 inside the bottle in the direction of arrows 224. Bubbles 226 filter through the liquid to pressurize the liquid and/or escape the liquid and pressurize the space between the liquid and the bottle walls and lid.

In an alternative configuration, as mentioned, the receiving port may alternatively be integrated into bottle lid 300. According to this configuration, the lid can be used with any bottle that has a mouth of the corresponding size and is adapted to hold a beverage under pressure. The receiving port is integrated into the lid together with the other components of the lid discussed elsewhere herein.

Once the liquid (and flavoring, if desired) is poured into the bottle and the lid is closed in an airtight manner, the bottle is turned over and the receiving port is placed onto the housing in a manner that allows a fluid connection between the gas canister and the fluid inside the bottle upon activation of the actuation mechanism. Aside from turning over the bottle, the manner of carbonating the beverage is the same as with the specialized bottle.

Bottle Cap/Lid

The cap/lid 300 has a dispensing mechanism built into it so that the carbonated beverage can be dispensed from the bottle 400 without removing the cap/lid once the beverage has been carbonated. In this manner, gas is not wasted either during the carbonation process (because the cap/lid is on at the time) or whenever the beverage is dispensed (because the cap/lid is not removed to dispense the beverage). The pressurized gas remains in the container and only liquid with gas (carbon dioxide) infused in the liquid exits the container when the beverage is dispensed. The pressure within the bottle, between the liquid and the walls/lid of the container also remains constant with the overall pressure in the bottle diminishing only as the liquid is evacuated from the bottle. Arrows 410 indicate the pressurized air pushing on the liquid.

The dispensing mechanism includes a spout 302, an airtight valve 304 and a straw 306. The dispensing mechanism draws liquid from the bottle through the straw, through the valve and out the spout. In the exemplary embodiment depicted in the FIGURE, the straw 306 extends from near the bottom of the bottle to the valve. The actuation mechanism, e.g. a plunger, causes fluid to be sucked up through the straw and out the valve, exiting the dispensing mechanism through the spout. Arrow 308 indicates the direction in which the liquid is suctioned up the straw 302. Of course, other dispensing mechanisms may be used in place of the depicted vacuum-plunger arrangement.

In addition, the bottle cap/lid includes a pressure relief valve 310. The pressure relief valve is a safety feature which prevents over pressurization of the bottle. The valve opens under a predefined amount of pressure. The predefined amount of pressure is the amount of pressure under which the bottle is likely to explode and/or the lid is likely to detach from the mouth of the bottle.

In some embodiments, the system can be programmed and actuated remotely via a dedicated remote control or, more preferably, via a smartphone 500 or other portable communications device. The base 100, according to the instantly described embodiments, includes a controller unit 130 (e.g. a microcontroller) that controls the actuation of the device as well as the various settings described above (velocity, duration, number of pulses etc.). Furthermore, the controller unit includes (or is in electric communication with) a wireless communication module adapted to send and receive wirelessly transmitted instructions and data.

The portable device is capable of wireless communication and may interact directly with the system or indirectly via a smart-home system that is in communication with the system 10. Either directly, e.g. using an installed app and communicating wirelessly with device 10, or indirectly (via the smart-home interface), the user can control each of the above-mentioned variables and can activate the system. It is made clear that while a portable communications device is specifically referenced, any type of computing device that can communicate with the system 10, either directly or indirectly, either via a wired- or wireless communications means, is considered to be within the scope of the invention. Wireless communications means include, but are not limited to, cellular, WIFI, infrared, Bluetooth as well as any other type of near or far acting wireless communication capabilities.

According to another configuration, also mentioned elsewhere herein, lid 300 has an integrated receiving port 200. The lid further includes the dispensing apparatus and a pressure relief valve 310. In the instant configuration, the bottle must either be inverted to be mated with the base as discussed above. Alternatively, the applicator can be located on an overhang arm (not shown) and attached to the receiving port 200 in the lid 300 while the bottle 400 is in an upright position. For example, the overhang arm may be part of a safety mechanism similar to the safety mechanism with an overhang arm described elsewhere herein that securely mates the bottle to the base.

It is made clear that any element or component described herein may be incorporated in the embodiment(s) with which it was described or may be incorporated in any other embodiment, mutatis mutandis, even if not described in relation to that specific embodiment. Any mechanical components described herein are to be viewed as replaceable with similar electromechanical components and/or, where applicable, digital/electronic components.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A system for introducing pressurized gas into a liquid, comprising:
(a) a housing adapted to receive a canister of pressurized gas, said housing including a threaded internal surface to receive a threaded neck of said canister;
(b) an applicator in fluid communication with said canister and operationally coupled to said housing;
(c) a liquid container adapted to hold therein a carbonated beverage;
(d) a receiving port adapted to be reversibly mated with said applicator in an airtight coupling so as to facilitate fluid communication of said pressurized gas into said liquid container.

2. The system of claim 1, further comprising an actuation mechanism for causing said pressurized gas to be communicated into said liquid container, said actuation mechanism being wiredly or wirelessly controlled.

3. The system of claim 2, wherein said actuation mechanism includes an actuator selected from the group comprising: a mechanical actuator, and an electro-mechanical actuator.

4. The system of claim 1, wherein said receiving port is embedded in a bottom surface of said liquid container.

5. The system of claim 1, wherein said receiving port is embedded in a side wall of said liquid container.

6. The system of claim 1, further comprising a bottle lid, said bottle lid adapted to be removably coupled to a mouth of said liquid container so as to form an airtight coupling when closed over said mouth.

7. The system of claim 6, wherein said bottle lid includes a dispensing mechanism for dispensing pressurized liquid from said liquid container without removing said bottle lid from said mouth of said liquid container.

8. The system of claim 7, wherein said dispensing mechanism includes an airtight valve to prevent said pressurized gas from escaping said liquid container via said dispensing mechanism.

9. The system of claim 6, wherein said bottle lid includes a pressure relief valve adapted to release said pressurized gas from said liquid container when a pressure level inside said container is above a predetermined threshold and to continue to release said pressurized gas until said pressure level drops below said threshold.

10. The system of claim 6, wherein said receiving port is integrated in said bottle lid.

11. The system of claim 1, wherein said receiving port has an outer side adapted to be external to said liquid container and an inner side adapted to be internal to said liquid container and a unidirectional valve disposed between said outer side and said inner side adapted to unidirectionally admit said pressurized gas from said outer side to said inner side.

12. The system of claim 1, wherein said applicator has a gasket disposed thereon for facilitating an airtight coupling with said receiving port.

13. The system of claim 1, further including a sensing mechanism configured to determine whether said applicator is mated in said airtight coupling with said receiving port.

14. The system of claim 13, wherein said sensing mechanism is selected from the group comprising: a mechanical mechanism, an electro-optical mechanism and an electronic mechanism.

15. The system of claim 1, further including a metering selector for selecting an amount of said pressured gas to be released upon actuation.

16. The system of claim 1, further including a velocity selector for selecting a velocity at which said pressured gas to be released upon actuation.

17. The system of claim 1, further including a pulse selector for selecting a number of pulses of a predefined amount of said pressured gas to be released upon actuation.

18. The system of claim 1, further including a timer for controlling a duration during which said pressured gas is to be released upon actuation.

19. The system of claim 1, further including at least one LED display adapted to indicate at least one of: a ready state, an in-use state, a number of pulses to be released, an amount of said pressured gas to be released.

20. The device of claim 1, wherein said housing further contains a locking mechanism adapted to secure said canister of pressurized gas therein.
